(19) United States
(12) Patent Application Publication
(10) Pub. No.: US 2020/0377405 A1
(43) Pub. Date: Dec. 3, 2020

(54) TRANSPARENT ARTICLES MADE OF GLASS CERAMIC WITH HIGH SURFACE QUALITY AND METHODS PRODUCING

(71) Applicant: SCHOTT AG, Mainz (DE)

(72) Inventors: Helga Gotz, Mainz-Kostheim (DE); Kyuchul Chung, Wiesbaden (DE); Marcus Datz, Mainz (DE); Rolf Hansen, Bretzenheim (DE); Friedrich-Georg Schroder, Ingelheim (DE)

(73) Assignee: SCHOTT AG, Mainz (DE)

(21) Appl. No.: 16/997,658

(22) Filed: Aug. 19, 2020

Related U.S. Application Data
(63) Continuation of application No. PCT/EP2019/054100, filed on Feb. 19, 2019.

(30) Foreign Application Priority Data
Feb. 19, 2018 (DE) 10 2018 103 661.2

(51) Int. Cl. C03C 10/00; C03B 13/04; C03B 32/02; C03C 19/00; C03C 1/00

(52) U.S. Cl. CPC C03C 10/0027; C03B 13/04; C03C 2204/00; C03C 19/00; C03C 1/004; C03B 32/02

(57) ABSTRACT

A transparent article made of glass ceramic with high surface quality as well as a method producing are provided. The article is suitable for use as a viewing pane. The method includes the steps of: producing a melt with a raw material composition that is suitable for a ceramization; hot shaping a flat substrate made of ceramizable green glass having two oppositely arranged, essentially flat surfaces from the melt; processing of at least one of the surfaces of the substrate with a smoothing fine-treatment process; ceramizing the substrate to produce the article made of glass ceramic.

### CROSS REFERENCE TO RELATED APPLICATIONS

This application is a continuation of International Application PCT/EP2019/054100 filed Feb. 19, 2019, which claims benefit under 35 USC 119 of German Application DE 10 2018 103 661.2 filed Feb. 19, 2018, the entire contents of both of which are incorporated by reference herein.

### BACKGROUND

### 1. Field of the Invention

The present invention relates to a transparent article made of glass ceramic with high surface quality as well as a method for the production thereof.

### 2. Description of Related Art

Glass ceramics, in particular transparent glass ceramics, are gaining increasing importance on account of their broad usability, even in fields with high temperature. This is due to the fact that glass ceramics exhibit a low thermal expansion, so that they can also be used in fields with strong temperature fluctuations.

Typical transparent glass ceramics are based on the LAS system with the main constituents lithium oxide, aluminum oxide, and silicon dioxide. The production of a LAS glass ceramic of this kind usually comprises providing a green glass, which is produced from a melt, whereby the green glass can be shaped into an article or into a glass ceramic plate. The green glass is then heated to a nucleation temperature, so that, with the help of nucleating agents, a large number of crystallization nuclei are produced in the green glass. Afterwards, the temperature is increased to an optimal crystallization temperature.

Production methods of this kind can be used to create an article made of glass ceramic that, in terms of its properties, also makes possible, for example, a utilization as a front viewing pane for fireplaces.

A use of a transparent glass ceramic as a viewing pane for fired appliances such as fireplaces, for instance, is known from DE 10 2016 216 305 A1, for example. Described in this publication is a fireplace viewing pane that can be used both in exterior and interior settings.

Also, DE 20 2014 004 209 U1 describes a fireplace viewing pane with a glass plate or a glass ceramic plate. In order to fit the fireplace viewing pane in the fireplace oven or in order to join it to other structural parts, a fitting made of a metal material is proposed.

The document DE 103 44 439 B3 describes a method for the production of glass ceramic plates with a wide facet cut.

The document DE 10 2010 023 407 A1 describes a glass ceramic object with a high chemical resistance toward a corrosive atmosphere.

The publication GB 1 322 796 describes a surface treatment of glass articles by means of a polishing method.

The publication JP 2013/112554 A describes a polishing method for glass substrates.

The publication JP 2015/176753 A describes a hob with a surface that is polished on its backside and that allows a coating to be applied.

The document US 2016/0075597 A1 describes a method for producing a flat article made of glass ceramic, whereby a polishing of the surface is carried out in order to reduce the roughness and to improve the transparency.

The publication DE 10 2010 043 326 A1 describes a method for the strength-enhancing ceramization of a floated, crystallizable glass. Resulting from the process, cracks are formed in the surface of the floated crystallizable glass due to the floating, whereby the forming gas atmosphere above the float bath is assumed to be the trigger for the cracks. These cracks are very deep and reduce the strength of the later product, so that the cracks on the surface of the floated glass cannot be eliminated in an economical manner by means of polishing either before or after the ceramization.

The publication DE 33 45 316 A1 describes a glass ceramic for use as a window glass in wood-burning or coal-burning stoves. In order to reduce or to prevent cracks and fractures in the surface of the glass ceramic, which arise when the glass ceramic is exposed to an atmosphere containing sulfuric acid, the glass ceramic is leached at the surface by use of an additional processing step. This additional processing step is very tedious and, in addition, entails risks, because hazardous substances are used.

In order to produce flat substrates made of glass ceramic, which are required for use as a viewing pane, a hot shaping by means of rollers is often employed.

Owing to production in a rolling process, however, fine scratches and/or microstructures can result on the surface of the article made of glass ceramic and this can lead to an increased reject or else necessitate a post-processing, which, in turn, can lead to further drawbacks.

It is presumed that, on the one hand, owing to the manufacturing tolerances of the shaping rollers, the surfaces of substrates made of ceramizable green glass always exhibit a slight, but measurable fine waviness. This fine waviness has proven to be detrimental to the subsequent ceramization of these substrates. Used here are often base plates or support plates, on which the substrates that are to undergo ceramization are carried through a continuous kiln or a roller kiln.

These support plates as well as the ceramization molds generally have a very smooth, specially adapted surface. When the substrates are then laid on the very flat support plates, air pockets, on which the substrate can slide, may form between the very smooth, flat support plates and the fine waves of the substrates. In the case of fully automatic transport systems, such as those typically encountered at the present time, such as, for instance, roller conveyors or chain conveyor belts, relative movements can then occur between the substrate and the support plate or ceramization mold. This can lead, in turn, to local damage of the surface and to the influencing of the strength associated therewith, even up to a strong drop in strength. In spite of diverse improvement measures, it has not been possible up to now to produce any surfaces in the rolling process that are free of these fine waves.

Manufacturing relics, which, owing to the processes involved, can occur in the various phases of production of a glass ceramic object after it leaves the melt, can also further contribute to local damage to the surface of substrates made of ceramizable green glass, in particular during hot shaping. These processes include, in particular, the rolling for shaping, but also the transport on corresponding transport rollers, as well as a ceramization. Manufacturing relics can thereby be, for example, small particles that can detach from the transport rollers, for example, and can remain on the surface of the green glass in the area of contact with the green glass that is transported out of the glass melt or can adhere to the surface owing to electrostatic charging, for instance. This adhesion is promoted still further by the high reactivity of the surface of the green glass when it comes directly out of the melt. These particles, which are often very small, are hardly perceptible at first, but they cause great problems during the subsequent ceramization or in a subsequent fine treatment, because they can lead to scratches on the surface.

A further drawback of the shaping by means of rolling is that, as a result of the contact with the rollers when the process is conducted, a slight microstructuring can be imparted to the surface, which interferes with applications in which a transparency is required.

For all of these surface disruptions due to the rolling process, there remains here solely the possibility of providing an additional, subsequent manufacturing step for fine treatment of the surface on the article made of glass ceramic, in order to reduce this fine waviness at least somewhat, to remove any particles that are present, or to smooth the microstructuring. Usually, however, these surface treatments entail a lapping process or a polishing process, which can lead to a reduction in mechanical strength.

Various tests have shown that the original level of strength can be achieved once again only with great difficulty and necessitates a tedious adjustment of different lapping and polishing parameters.

A further drawback is to be seen in the fact that a reduction of the surface layer, which, in particular in the case of an article made of glass ceramic, may be lithium-poor caused by the manufacturing process, can lead to a marked reduction in resistance against chemical products arising from combustion.

### SUMMARY

Therefore, a method would be desirable for the production of a flat, transparent article made of glass ceramic for use, for example, as a bullet-resistant viewing pane, that is, in a layered composite, as a cooktop, as a stove or fireplace viewing pane, as a window plate for baking oven doors, as a support plate for precious metal coatings, as a display protector cover, or as a non-imprinted or imprinted hob or countertop or work table, which, in particular, is large in size, being at least 0.7 m², preferably at least 1.0 m² in surface area, which makes it possible, on the one hand, at least to reduce tedious post-processing operations, such as a fine treatment of the surface, and, on the other hand, also allows substrates of this kind to be produced with high strength and resistance.

An article made of glass ceramic that is produced in this way is intended to have, in addition to the reduction of the fine waviness, also a flawless surface with as little damage as possible. This means that the produced surface should also be as free as possible of scratches or other damage that is perceptible to the human eye.

The mechanical properties, in particular the strength, of the article made of glass ceramic are thereby to be retained as unaltered as possible. Preferably, this strength should correspond to the strength of an unpolished article made of glass ceramic or should be still higher, even when an additional polishing step is carried out. In addition, a good impact strength should also be provided.

Finally, the resistance against chemical products of combustion residues should remain as unaltered as possible and lie at least at the level of an unpolished viewing pane.

In particular, a use as a protective viewing pane for fireplace stoves, pellet stoves, or incinerators should be possible, whereby an especially high resistance against combustion products, in particular against sulfur-containing exhaust gases, which can contain compounds made of sulfuric acid or even sulfuric acid itself, should be made possible. This means that at least one surface of the produced article made of glass ceramic, preferably the surface that faces the combustion region, should have a correspondingly high resistance.

The glass ceramic articles produced in this way are intended to be utilized, in particular, in fields that are characterized by strong temperature fluctuations and/or by mechanical loads, for example, as cookware, as a glass ceramic cooktop, or in the sector of fire protection.

The inventors have addressed this object.

This object is surprisingly achieved by a method for producing a flat, transparent article made of glass ceramic for use as a viewing pane, such as, for example, as a bullet-proof viewing pane, also in a layered composite, as a cooktop, as a stove or fireplace viewing pane, as a window plate for baking oven doors, as a support plate for precious metal coatings, as a display protector cover, or as a non-imprinted or imprinted hob or countertop or work table, which, in particular, is large in size, being at least 0.7 m², preferably at least 1.0 m² in surface area, as well as a flat, transparent article made of glass ceramic in accordance with the present disclosure

Accordingly, the subject of the invention is a method for producing a flat, transparent article made of glass ceramic for use as a viewing pane, comprising the following steps: production of a melt with a raw material composition that is suitable for a ceramization, production of a flat substrate made of ceramizable green glass having two oppositely arranged, essentially flat surfaces from the melt by means of hot shaping, processing of at least one of the surfaces of the substrate with a smoothing fine-treatment process, ceramization of the substrate in order to produce the article made of glass ceramic.

The method according to the invention can preferably find application in the field of the industrial production of flat, transparent articles made of glass ceramic. The method can optionally comprise the downstream treatment of another surface of the article made of glass ceramic, in particular the surface that is opposite-lying to the surface that undergoes fine treatment prior to the ceramization and that, during the ceramization, is in contact with a base support.

Typically, in order to produce a glass melt, a batch having a composition that is suitable for later ceramization is fed to a glass melting facility and melted. By means of various methods, it is possible to produce glass bodies from this batch, whereby the glass that comes directly from the glass melt is also referred to as so-called green glass. Accordingly, green glass is understood to mean a glass that originates directly or indirectly from the glass melt. Insofar as the green glass is referred to as “ceramizable,” this means, in the sense of the invention, that this green glass is suitable for being ceramicized in a ceramization process and can be transformed into a glass ceramic, but also that this ceramization process has just not yet occurred or is not yet concluded.

Accordingly, in the case of a ceramizable green glass, the crystal formation, which is also referred to as the crystallization or ceramization, has not yet taken place or at least has not yet taken place to a notable extent. The ceramizable green glass thus contains nucleating agents for crystal formation in order to be ceramizable, but the crystalline fraction is still very low. In particular, the crystalline fraction of the ceramizable green glass is less than 20 vol %, preferably less than 10 vol %, and especially preferred less than 5 vol %.

Insofar as a ceramizable green glass is mentioned in the following, it is understood to mean, first of all, a rolled ceramizable green glass that is obtained continuously from a glass melt. Insofar as this ceramizable green glass is separated into pieces by means of scoring and breaking, for example, these separated sections are also referred to as a substrate made of ceramizable green glass or as substrates made of ceramizable green glass.

The smoothing fine treatment of the at least one surface of the ceramizable green glass can fundamentally occur here not only on a substrate made of ceramizable green glass, but also directly on a rolled, continuously manufactured glass ribbon, that is, already prior to a separation into pieces, as the substrate. Based on its better handling, however, the smoothing fine treatment on correspondingly separated substrates offers itself.

In accordance with the invention, the ceramizable green glass can be based on the lithium aluminosilicate system (LAS glass ceramic) and can have nucleating agents, which can comprise preferably TiO₂ and/or ZrO₂ or also SnO₂. The ceramizable green glass can have the range of composition presented below (in wt. %):
50-75 SiO₂, preferably 58-74 SiO₂, especially preferred 60-73 SiO₂,
15-28 Al₂O₃, preferably 15-25 Al₂O₃,
0-3.0 B₂O₃, preferably 0-2.0 B₂O₃,
0-1.0 F,
2.0-6.0 Li₂O, preferably 2.0-5.5 Li₂O, especially preferred 2.5-5.0 Li₂O,
0-6.5 CaO+SrO+BaO, preferably 0-6 CaO+SrO+BaO, especially preferred 0-5 CaO+SrO+BaO,
0-7.0 TiO₂, preferably 0-6.0TiO₂, especially preferred 0-5.0 TiO₂,
0-5.0 ZrO₂,
0-5.0 ZnO,
0-3.0 Sb₂O₃,
0-3.0 MgO,
0-3.0 SnO₂,
2.0-7.0 TiO₂+ZrO₂+SnO₂,
0-9.0 P₂O₅,
0-2.0 As₂O₃, preferably 0-1.5 As₂O₃,
0-4.0 Na₂O+K₂O, wherein the respective proportions lie within the ranges given below:
0-4.0 Na₂O,
0-4.0 K₂O,
preferably 0-3 Na₂O+K₂O, wherein the respective
proportions lie within the ranges given below:
0-2.0 Na₂O,
0-2.0 K₂O;
especially preferred 0-1.2 Na₂O+K₂O, wherein the respective proportions lie within the ranges given below:
0-1.0 Na₂O,
0-0.5 K₂O;
as well as conventional refining agents such as Sb₂O₃, As₂O₃, SnO₂, Ce₂O₃, fluorine, bromine, and sulfate, for a water content of 0.01-0.08 wt. %.

The production occurs in a plurality of stages and is briefly outlined below. First of all, the ceramizable green glass, which is referred to below as the crystallizable starting glass, is melted and refined from a mixture consisting of shards and powdered batch raw materials in accordance with the composition mentioned above. In this case, the glass melt reaches temperatures of 1,550° C. up to at most 1,750° C., generally up to 1,700° C. In some cases, a high-temperature refining above 1,700° C., usually at temperatures around 1,900° C. is employed. After the melting and refining, the glass usually undergoes a hot shaping by rolling, casting, pressing, or floating, as a result of which a flat substrate made of ceramizable green glass is formed. This flat substrate here can comprise two nearly planar lateral faces arranged opposite to each other, which are also referred to below as surfaces, and is thus plate-shaped or panel-shaped.

In many cases, rolling is advantageous for the hot shaping in the production of flat substrates, such as plates or panels, from the glass melt. Commonly used rolling processes comprise at least one pair of rollers that rotate in opposite directions in relation to each other, the utilization thereof also being possible in the present case. Obviously, it is also possible to utilize a plurality of successively arranged rollers, in which case the desired thickness is achieved in steps.

In an especially advantageous embodiment, the method according to the invention for the production of a flat, transparent article made of glass ceramic thus comprises a rolling process for the hot shaping; that is, the ceramizable green glass passes through at least one pair of rollers that rotate in opposite directions relative to each other. These rollers are also referred to below as shaping rollers. For the transport by the at least one pair of rollers, preferably transport rollers are used, on which the ceramizable green glass can rest and which can be driven in order to transport the ceramizable green glass resting on them.

Desired for the economical production of these glass ceramics based on the LAS system are, on the one hand, a low melting temperature and a low processing temperature VA for the hot shaping. On the other hand, the glass may not exhibit any devitrification during shaping, which means that no interfering crystals may form, because they could lower the strength in the glass ceramic articles or have a visually disturbing effect.

The critical coldest area during the shaping over rollers is the contact of the glass melt with the drawing nozzle, which is made of precious metal, before the glass is shaped into flat substrates by the rollers and is cooled. This contact of the hot glass melt with the substantially cooler shaping rollers and/or the transport rollers can very often lead to a fine waviness on the rolled substrate.

Accordingly, the rolling process and/or the transport process can result in a waviness in the region of the surface of the ceramizable green glass. In the scope of the invention, this waviness is referred to as a fine waviness. The waviness or the fine waviness thus refers to an unevenness of the at least one surface of the ceramizable green glass, which can manifest itself periodically over longer distances as roughness and which thus represents a deviation from an ideal, planar surface. The waviness can occur periodically, that is, repeatedly, with longer intervals, as viewed in relation to the depth. In the present case, there can result a fine waviness with a wavelength in the range of about 5 mm to about 500 mm, by which what is meant is thus the distance between two neighboring wave valleys or wave peaks.

The specific wavelength is dependent on various process parameters, such as, for instance, the diameter of the shaping rollers and/or transport rollers or the temperature difference between the surface of the shaping rollers and/or the transport rollers and the ceramizable green glass in the region of contact.

During the subsequent ceramization, this fine waviness on the rolled flat substrate can lead to damage on the surface of the article made of glass ceramic, which markedly restricts the usability of the article as a viewing pane, for example, and/or can reduce the yield. This will be briefly outlined below.

During the ceramization, the substrates can be placed on a smooth base support, which is also referred to as a support plate and serves as kiln furniture. In general, the support plates can be produced from a material that is stable to high temperatures, comprising a ceramic material or also a glass ceramic material. What is involved in the latter case are usually so-called base plates made of glass ceramics, which contain predominantly keatite mixed crystals (KMC). A support plate made of keatite is described, for example, in U.S. Pat. No. 7,056,848 B2 as well as in DE 102 26 815 B4 of the same applicant.

Obviously, it is also possible to ceramicize different substrates that are to be ceramicized and lie separated by intermediate layers, such as support plates or separating means, stacked on a support plate. The ceramization in so-called ceramization molds, such as those that are known to the person skilled in the art for gravity sagging processes and are described, is dependent on as little as possible fine waviness of the green glass.

In addition to the fine waves, other unfavorable surface properties can exist, such as, for example, microstructures, which will be addressed further below. The applying of the flat substrate having microstructures onto the support plate can lead to the fact that air pockets are created between the microstructures or the fine waves on the surface of the substrate and the very smooth, flat surface of the support plate and the substrate can slide on these air pockets. In the case of fully automatic transport systems, such as those typically encountered at the present time, such as, for instance, roller conveyors or chain conveyor belts, relative movements between the substrate and the support plate can then occur. Of course, the above-mentioned microstructures and/or the fine waves on the rolled surface of the substrate have proven to be problematical. This, in turn, can lead to local damage to the surface of the substrate, such as, for instance, in the form of fine scratches in the region of wave inclines as a result of the relative movements with respect to one another and, associated therewith, a strong drop in strength. Glass ceramic surfaces that are damaged by scratches break markedly faster when they are subjected to tensile stress. The tensile stress can widen the cracks and, under an impact load, breakage is then more likely to occur.

The aforementioned microstructuring of the surface of the ceramizable green glass is ascribed to the temperature difference between the surface of the shaping rollers and/or the transport rollers, on the one hand, and the ceramizable green glass, on the other hand. In the region of contact, there can result a texturing of the surface of the ceramizable green glass that overlaps the fine waves, which can lead to a “porousness,” which is similar in appearance to that on the surface of an orange and accordingly is also referred to as an “orange skin.” The wavelength of this microstructuring lies at less than 1 mm, often in a range between 0.002 mm and 0.005 mm.

This microstructuring can influence more or less strongly the transparency of the later article made of glass ceramic and, in the most unfavorable case, even can make impossible any use of the article made of glass ceramic as a viewing pane. The porousness of the surface leads to the fact that, when an object on the other side of the article is viewed through the finished article made of glass ceramic, for instance, this object will appear as being blurred. For this reason, usually as a last processing step, that is, after the ceramization, a fine treatment of the surface, in particular a polishing of the surface, is carried out.

The inventors have found that this downstream fine treatment of the surface of a transparent article made of glass ceramic that is produced in the rolling process is unfavorable for various reasons.

First of all, a material-removing, smoothing fine treatment, such as, for example, a polishing or a lapping, after the ceramization, that is, on the article made of glass ceramic, is unfavorable, because the so-called “glassy zone,” that is, a lithium-poor, near-surface layer or surface layer, which can arise starting at the surface of the substrate during the ceramization, is reduced or is even entirely removed. This layer can be produced by a suitable adjustment of the kiln parameters during the ceramization.

However, a reduction or removal of this layer is insofar unfavorable, because this layer has a high resistance against acid or acid-containing gases, such as those that can form as combustion products in the combustion spaces of fireplaces, for instance. Therefore, an especially high resistance toward such sulfur-containing exhaust gases, which can contain compounds made of sulfur-containing acid or even sulfuric acid, is of great importance for an article made of glass ceramic that is to used, for instance, as a fireplace viewing pane.

In addition, it has been found that very small particles adhering to the surface of the ceramizable green glass remain stuck there during the ceramization and, during the later fine treatment, such as, for instance, a polishing or lapping, can lead to further damage on the surface and, in particular, can lead to scratches, so-called “comet scratches.” These particles, which are not visible to the human eye beforehand, can thus lead to markedly visible, undesirable surface appearances of the finished article.

The microscopically small particles can be manufacturing relics or other foreign materials that are created during the hot shaping, such as, for instance, particles from the transport rollers. When small particles of this kind detach from the transport rollers, for instance, they can adhere to the surface upon contact with the ceramizable green glass owing to electrostatic charging, for instance. Even when these very small particles are barely or not at all perceptible visually to the human eye, they can cause great problems during the subsequent fine treatment, that is, after the ceramization has been concluded, because, as a result of the polishing, they are moved on the surface and can thus can cause scratches on the surface. This is further complicated by the fact that these resting or adhering particles can penetrate deeper into the material during the ceramization and thus cause even deeper scratches.

In connection with the fine waviness of the surface, the above-explained relative movements between the substrate made of ceramizable green glass and a support plate can already result in visible scratches of this kind during the ceramization.

Surprisingly, it has been found that the processing of at least one surface of the substrate made of ceramizable green glass, which, in particular, is based on the LAS system, with a smoothing fine-treatment process prior to the ceramization offers various advantages.

A smoothing fine treatment, in particular a polishing or lapping of at least one surface of the ceramizable green glass, leads to the fact that the fine waviness can be reduced to such an extent that the substrates made of ceramizable green glass no longer slide on the smooth base support and the surfaces are no longer scratched as a result of the relative movements that thereby result.

In a highly advantageous manner, a smoothing fine treatment of the surface of the ceramizable green glass leads to the fact that particles that adhere to or rest on this surface can be removed.

In a further highly advantageous manner, it is also possible thereby to eliminate the microtexturing of the surface, that is, the “orange skin.”

Thus, in accordance with the invention, at least one surface of a ceramizable green glass is subjected to a fine treatment, in particular a polishing process or a lapping process, whereby the ceramizable green glass was produced by the rolling process, and whereby, in the course of the production, this surface has stood in contact with at least one shaping roller and/or with transport rollers, and whereby the crystalline proportion of the ceramizable green glass is less than

20 vol %, preferably less than 10 vol %, and especially preferred less than 5 vol %.

In accordance with the invention, it is therefore provided to carry out a smoothing fine treatment on at least one surface of the substrate made of ceramizable green glass. In this stage of the method, therefore, no article made of glass ceramic is yet present, because the ceramization has not yet taken place. This is surprising insofar as it has hitherto been assumed that treatment processes of this kind can be employed only in the case of articles that have already been ceramicized, because the fine treatment can lead to a further surface change of the surface being treated. The smoothing fine treatment is therefore preferably conducted in such a manner that only the fine waviness is reduced to a predetermined extent.

Surprisingly, it has been found that, during the subsequent ceramization of the substrate made of ceramizable green glass, a reduced, slight fine waviness of the surface leads to the fact that the air pockets on the very smooth support plates are strongly reduced in size and, in part or for the most part, are no longer present. The relative movement of the plate when it travels through the kiln is thereby strongly reduced or, in the ideal case, no longer takes place.

Accordingly, even a slight reduction in the fine waviness, which is essentially limited to the removal of the wave inclines, can lead to a marked reduction in the scratches on the surface as a result of the ceramization. The surface of the substrate can thus be retained in its original quality to a certain degree in the treated area, insofar as the fine treatment relates solely to the reduction of the wave inclines, but does not fully smooth them. In this first embodiment, therefore, the original roughness of the surface of the substrate can remain unchanged, in particular in the wave valleys. The material removal can occur here down to a depth, measured from the surface, preferably from a wave peak, that represents about half of the amplitude of the waves and this thus can represent a good compromise between the extent of the fine treatment on the one hand and the reduction in the waviness on the other hand. This method can be employed very economically and comes to fruition preferably in the case of articles made of glass ceramic or product groups for which a very good transparency and the absence of a microstructure are not required. These product groups can be, for example, colored or volume-colored glass ceramics.

Accordingly, a low fine waviness of the treated surface is likewise retained and thus makes possible a fast economical processing. The goal of the fine treatment will therefore not be a complete removal of the wave inclines, as is generally the case for a grinding or smoothing of the surface by means of polishing, but rather a residual fine waviness of the surface is instead tolerated.

In an advantageous way, this has the further consequence that the mechanical strength remains at a high level and a lithium-poor area on the surface can be retained. Accordingly, the final product, that is, the substrate after the ceramization, continues to be resistant against the chemical products of combustion residues.

By way of the fine treatment of the surface prior to the ceramization, it is possible, in particular, to reduce the fine waviness to such an extent that the substrates made of green glass barely slide on the smooth support plates any longer or, in the ideal case, do not slide on the smooth support plates at all when they are laid with this post-processed surface on the support plates. It can be achieved thereby that the surfaces are scratched markedly less or, in the ideal case, no longer scratched at all due to resting on the support plates and as a result of transport, in particular during the ceramization.

The scope of the fine treatment of the ceramizable green glass as explained above does not completely remove the microstructures and/or particles discussed further above or removes them essentially only on the “wave inclines”; thus, for articles made of glass ceramic or product groups for which a flawless transparency is required, this can be a drawback. Accordingly, for the surface of the ceramizable green glass that is to be treated, a total proportion of the surface of at least 10%, preferably at least 20%, and especially preferred of at least 30%, at least 40%, or even 50% or even more can remain untreated and thus can continue to represent the surface in its original nature. This relatively low extent of the smoothing fine treatment can be carried out especially rapidly. Accordingly, in principle, it is also possible to apply this method directly to a glass ribbon.

In an especially advantageous second embodiment of the invention, therefore, it is proposed to provide for a small material removal, which nonetheless occurs over the entire surface. In this case, it is possible to exploit the fact that a certain fine waviness may be retained. In other words, by way of the fine treatment, that is, for example, the polishing or lapping, not only material in the region of wave inclines is removed, but also material in the region of wave valleys is removed. Accordingly, the corresponding surface of the substrate is treated in full; that is, a removal of material takes place over the entire surface. However, the extent of the material removal here can be different, preferably stronger in the region of wave inclines and weaker in the region of wave valleys, in order to reduce the fine waviness.

In this way, not only is the fine waviness reduced, but also a potential microstructuring, in particular a potential orange skin, is eliminated. Therefore, the removal preferably takes place down to a depth at which the microstructurings are eliminated as completely as possible. In general, for a removal of material over the entire surface, a material removal with a depth in a range from about 0.1 μm to 5 μm, preferably from 0.1 μm to 1 μm, as measured from the surface, is sufficient in order to eliminate any pores and particles that are present. In this way, the fine treatment can be realized in a time-saving and cost-effective manner. In an especially advantageous manner, a removal of material over the entire surface leads to the fact that it is also possible to remove particles that are present on the surface of the ceramizable green glass and are found in the region of wave valleys.

In an especially favorable embodiment, therefore, only one surface of the ceramizable green glass is subjected to fine treatment, that is, for example, polished or lapped, prior to the ceramization. Preferably, the surface in question is the surface that, during the hot shaping, had the most contact with the shaping rollers and/or the transport rollers, because, in this case, there exists the greatest risk of adherences. In general, what is involved is the bottom side of the ceramizable green glass, which rests on the transport rollers and which thus has the most frequent contact with other surfaces.

A smoothing fine treatment can be produced, for example, by a material removal tool that has at least one material removing face, whereby material can be removed from the surface of the substrate made of ceramizable green glass that is to be post-processed. In this case, the material removal tool can have at least one material removing face that rotates around an axis perpendicular to the material removing face and the material removal tool is guided along predetermined tracks with constant advance, for example, but with different process parameters, such as pressure and speed of rotation, over the surface to be post-processed, whereby the tracks overlap one another. It is possible here to add a bonded abrasive or a loose abrasive, as a grinding agent or a polishing agent, and/or a cooling agent.

An exemplary smoothing manufacturing method is presented, for example, in the publication DE 10 2010 033 041 A1 of the same applicant, which is incorporated herewith to the full extent.

This document presents a method for the smoothing fine treatment of a surface of a flat substrate made of glass or glass ceramic, in which with a plurality of material removal tools, material is removed from the surface of the substrate that is to be post-processed, wherein the material removal tools have material removing faces that each rotate around an axis that is perpendicular to the material removing face, wherein the material removal tools are guided along predetermined tracks, in particular with identical advance, but preferably different process parameters, such as pressure and speed of rotation, over the surface to be post-processed, wherein the tracks overlap one another, and wherein at least one first material removal tool grinds the surface that is to be post-processed with a bonded abrasive as a grinding agent having a first grit and at least one second material removal tool polishes the surface that has been ground by the at least one first material removal tool with a second, loose abrasive as a polishing agent, which, in comparison to the first grinding agent, has a finer grit, wherein the second abrasive comprises a slurry, and wherein during the grinding, this slurry is also introduced between the material removing face of the at least one first material removal tool as an additional fine-grained abrasive plus cooling agent and the surface that is to be post-processed.

Material removal processes of this kind involving a plurality of material removal tools, which are simultaneously engaged, are especially economical to operate.

In particular, for a removal of material over the entire surface in accordance with the second embodiment, it is appropriate when, instead of a rigid material removing head, the material removal tool comprises a flexible material removing head. Conceivable in this case are flexible polishing heads, for instance, which smooth out a waviness and can exert a constant contact pressure over the surface area.

Although the material removal processes thus far take place at the same time, since the first material removal tool and the second material removal tool process the surface at least partially at the same time, the material removal processes are nonetheless staggered in time, because the second tool polishes the surface areas that have already been processed by the first tool.

First of all, therefore, the first material removing process is started by advancing the fine grinding tool into the workpiece and, after processing of the first tracks, the second material removing process is started by advancing the polishing benches into the workpiece that has already been pretreated by the fine grinding tools. Lastly, the first material removing process is also terminated as the first process by retracting the fine grinding tools before the polishing benches are also retracted out of the tool after the last tracks have been traversed. Consequently, the tools therefore process the workpiece in part simultaneously, but do not process the same area of the surface at the same time.

An exemplary device for the smoothing post-processing of flat substrates made of ceramizable green glass is based on at least one material removal tool and a movement mechanism, by means of which the at least one material removal tool is guided over a surface of the substrate to be post-processed and material is removed by the at least one material removal tool, whereby the at least one material removal tool has material removing faces and a rotational drive, by means of which the material removing faces can each be rotated around an axis that is perpendicular to the material removing face, whereby the movement mechanism is designed in such a way that the at least one material removal tool is guided along predetermined tracks, in particular with identical advance, but, if need be, also with different process parameters, such as pressure and speed of rotation, over the surface to be post-processed, whereby, in the case of a plurality of material removal tools, the tracks overlap one another, and whereby at least one material removal tool has a polishing head as a material removing face, whereby a feed device is provided, which feeds a loose abrasive to the polishing head in the form of a slurry, and whereby this slurry is also fed, by means of a feed device, to the surface that is to be post-processed.

In a further development, at least one second material removal tool is provided, whereby the first material removal tool has a material removing face with a grinding agent having a first bonded grit, and whereby the second material removal tool has a polishing head as a material removing face, whereby the feed device feeds to the polishing head a second, loose abrasive, which, in comparison to the first grinding agent, has a finer grit, in the form of a slurry.

This method is well-suited for the post-processing of flat substrates made of glass ceramic, but can also be employed surprisingly well for the smoothing fine treatment of flat substrates made of ceramizable green glass, as explained above.

The substrates can have thicknesses in the range of 1 to 10 mm and exhibit here thicknesses fluctuations of up to 200 micrometers. The plates preferably have a surface area greater than 1 m², because the high effectiveness of the method in accordance with the invention is manifested especially for substrates of large surface area.

In terms of the movement of the material removal tools over the substrate to be post-processed, it has proven to be especially advantageous in regard to a uniform removal of material when the material removal tools are moved by means of a corresponding suitable movement mechanism along tracks that are parallel to one another. Furthermore, the tracks are preferably straight-lined tracks. By way of straight-lined, parallel tracks, it is possible to set precisely the duration of action of the material removal tools on the surface areas. In addition, in this way, a uniform duration of action is achieved over the entire post-processed surface. However, it is not ruled out that this goal can also be achieved possibly by using another pattern of movement. However, in view of the shortening of the process time, a treatment time that is uniform over the entire surface is given special importance. In contrast to this, such a shortening of the processing duration could not be achieved by way of a completely stochastic or virtually random movement, because, in this case, it would be necessary to grind and/or to polish for a long time in order to achieve once again, on average, a uniform removal of material over the entire surface. Nonetheless, however, a further, likewise stochastic movement can be superimposed on the tracks in order to prevent, for instance, a stepwise difference in heights at the edges of the tracks.

Beyond this, the method makes possible a uniform removal of material up to the edge of the flat substrate made of ceramizable green glass when, during the material removal, the at least one material removal tool is moved with the edge of the material removing faces over and beyond the edge of the substrate, whereby the axis of rotation here remains on the substrate. For the uniformity of the material removal at the edge, in this case, it is favorable when the at least one material removal tool is moved over and beyond the edge by at least up to a third of the diameter of the material removing faces.

Obviously, in the case of more than one material removal tool, the material removal tools are guided here over the surface of the substrate that is to be post-processed in such a way that the areas of the surface are each traversed first by the at least one first material removal tool and then, afterwards in time, by the at least one second material removal tool on a machine without any handling effort between the two processing steps.

Of great advantage is that for both process steps, the slurry that is utilized as an abrasive for the polishing can also function as an abrasive and/or as a cooling agent for the grinding head or the first material removal tool. It is likewise advantageous that, without losses in quality, it is possible to operate the slurry in circulation, without incurring the risk in the polishing step of producing scratches due to grinding particles that are released from the material removing face of the first tool. In this case, it is noteworthy that even a single grain of the coarser grinding agent having the first grit on the polishing head can nullify the entire polishing result.

In accordance with a preferred further development of the invention, therefore, the slurry is operated in circulation, whereby the slurry that remains after the grinding or polishing steps is collected again and is fed back to the material removal tools. In accordance with this further development of the invention, therefore, a circulating feed device for the slurry is provided, whereby the circulating feed device comprises a device for the collection of the slurry that remains after the grinding and polishing and a device for renewed feeding of the collected slurry to the first and second material removal tools.

A slurry is, in general, a suspension or dispersion of an abrasive agent in a liquid. Preferably utilized as a slurry is a suspension of cerium oxide in water. However, other abrasives and also liquids are also possible, such as, for example, oils and additives for preventing the sedimenting and agglomerating of the abrasive grains in the water. Suitable are various phosphates, such as, for example, monosodium phosphate hydrate (NaH₂PO₄), disodium phosphate (Na₂HPO₄), or sodium pyrophosphate (Na₄P₂O₇), as well as organic salts, such as sodium citrate (C₆H₅Na₃O₇ or C₁₂H₂₅NaOS).

With this method, it is further possible to realize the different processes of grinding and polishing on a machine without separate control of the liquid process intakes and outlets or with a common in-feed and out-feed of abrasive agent and cooling agent for both process steps. It was thus possible to save nearly 40% of the otherwise usual process time with separated grinding and polishing operations.

The grinding agent having a first grit preferably has a grit of at least 8 micrometers, especially preferred a grit of up to at most 40 micrometers. Utilized for the slurry is an abrasive with a grit of preferably less than 2 micrometers in the case of normal distribution. The above-stated sizes each relate to the mean diameter of the grains. For the at least one material removal tool, diamond foils or diamond-covered metal disks have proven useful. However, it is also possible to use other abrasive substances, such as, for example, corundum, silicon carbide, etc. For the material removing face of the polishing tool, felt or an elastomer, preferably polyurethane, has proven to be best.

When the slurry is operated in circulation, it is then favorable to provide a separation device, which is upstream of the device for renewed feeding of the slurry and can be used for separating coarse and fine fractions of solids in the slurry. The slurry obtained from the return flows of the slurry discharged from the overall process generally has fractions of coarse abraded material due to the fine grinding or the material removal of the first material removal tools, corresponding fine abraded material from the polishing process involving the at least one second material removal tool, foreign particles from the surroundings, and a varying distribution of grain sizes of the abrasive of the slurry.

In order to sieve the solids fraction and to separate it suitably into coarse and fine fractions, a centrifuge or a cyclone is especially suitable. Due to the separation, it is then possible to ensure the renewed inflow to the two process steps of the fine grinding and the polishing with the underflow containing the coarse fractions of the slurry for the fine grinding and to ensure the supply of the polishing process from the overflow with the fine fractions of the slurry, which has the coarse fraction of solids but, above all, no longer has any fraction of the grinding agent having the first grit. Conceivable among other things is also a sedimentation tank, which, however, takes longer to act than does a centrifuge or a cyclone, so that, in this case, a larger quantity of slurry needs to be supplied overall. Regardless of the kind of separation device, it is then advantageous when only the fraction of the slurry containing finer solids is fed to the material removal tools.

It has further proven to be favorable for a fast and uniform removal when the diameter of the material removing faces differs for the grinding operation and the subsequent polishing. In particular, it is favorable when the material removing face of the at least one first material removal tool has a larger diameter than the material removing face of the at least one second material removal tool. In order to be able to level out effectively the typical differences in thickness brought about during rolling of the glass down to 200 micrometers, a diameter of the first material removing face of greater than 500 millimeters is favorable for glass/glass ceramic plates, in particular those with the mentioned surface area greater than 1 m². The diameter of the material removing face of the at least one second material removal tool is then correspondingly chosen to be smaller than 500 millimeters.

In regard to a uniform removal, it is further favorable when the tracks that are traversed by the material removal tools overlap by at least 20%, preferably by at least a third of their width or of their diameter. This applies preferably separately in each case for the tracks traversed by the first material removal tool or first material removal tools as well as for the tracks traversed by the second material removal tool or second material removal tools. If the tracks overlap too little, visible strips of differing height can be caused to appear along the tracks.

In order to keep the processing time short, moreover, it is advantageous to guide the material removal tools in a meandering path over the surface to be post-processed. For this purpose, the material removal tools can be moved forward and backward in direction along the tracks during material removal, whereby, intermittently, the plate that is to be processed is moved transversely to the tracks relative to the material removal tools.

In order to save process time, it is possible to carry out the process, in terms of the grit of the abrasives, as solely a two-step process. In other words, it is sufficient to use only two different grits, namely, the coarser and bonded grit of the abrasive of the first material removal tool and the finer grit of the abrasive in the slurry. However, in accordance with this further development of the invention, it is obviously possible in each case to use a plurality of first and/or second material removal tools.

Through the fine-treatment process, wherein the above-named process is mentioned solely by way of example, it is possible to provide a substrate made of ceramizable green glass that has at least one very flat, smooth surface with little fine waviness and little roughness. The smoothing fine treatment can take place directly after the rolling, that is, subsequent to the hot shaping. After the smoothing fine treatment, the fine waviness of the flat substrate made of ceramizable green glass is therefore less than before, that is, directly after the hot shaping.

Fundamentally, for the final product made of glass ceramic, a waviness that is clearly visible to the eye is composed of two parameters. On the one hand, the amplitude is crucial. However, the visibility of this amplitude depends directly on the wavelength of the waviness. In general terms, it can be stated that the greater the wavelength of the waviness, the greater can also be the amplitude of the waviness, without this being perceived by the eye. A waviness that is visible to the eye is provided, for example, for amplitudes greater than 50 μm in connection with wavelengths smaller than 135 mm.

By application of a smoothing fine-treatment process on the surface of the ceramizable substrate, it was possible to achieve a reduced fine waviness of the treated surface that can be defined as follows:

The achievable waviness of the ceramizable green glass or of the substrate made of ceramizable green glass is at most 500 preferably at most 50 and most especially preferred at most 10 measured as the difference in height between a wave valley and an adjacent wave peak. A minimum waviness of about 0.1 mm up to 0.2 mm, in contrast, seems not to be critical for the ceramization, but, on the other hand, it favors a more fixed and more stable resting of the substrate on the support plate. For this reason, therefore, the waviness of the substrate after the fine treatment is preferably at least 0.1 mm or at least 0.2 mm. The achievable waviness of the wavelengths lies between 50 and 500 mm, preferably between 60 and 200 mm.

The roughness of the surface of the substrate treated by the smoothing fine-treatment process in accordance with the first embodiment, in which predominantly wave inclines are subjected to material removal, in this case, changes essentially nothing. The maximum roughness Ra is at most 0.5 μm in the most unfavorable case and normally lies in the range of 0.2 μm-0.5 μm.

In contrast, the roughness of the surface of the substrate treated with the smoothing fine-treatment process in accordance with the second embodiment, in which the material removal occurs over the entire surface, is less than the original roughness and is Ra<0.02 μm, preferably Ra<0.010 μm.

After the smoothing fine treatment of the at least one surface of the substrate made of ceramizable green glass, the ceramization process takes place in order to obtain the flat, transparent article made of glass ceramic. This can be produced in the way briefly outlined below, as is also described in the publication WO 2012/019833 of the same applicant and which is incorporated herewith to the full extent. Through the method for ceramization outlined here, it is possible to produce a highly transparent and, at the same time, high-strength glass ceramic article, which is characterized by its short residence times in the nucleation phase and crystallization phase.

For this purpose, the flat substrate comprising the ceramizable starting glass, in which the nucleating agents are contained, is provided and the substrate is subjected to a heat treatment, wherein the starting glass is heated first of all to a nucleation temperature in the range of 700 to 810° C., with the residence time in this temperature range lying between 3 and 120 minutes, and subsequently the starting glass is heated with the formed nuclei from the nucleation temperature to 810 to 880° C., whereby the rate of heating is from 0.1 to 5.0 K/min, and subsequently the at least in part already ceramicized starting glass is heated to temperatures in the range between 880 and 970° C., wherein after the heating, the at least partially crystallized starting glass is held for several minutes in this temperature range and the duration of this process step lies between 1 minute and 45 minutes, and finally a cooling of the glass ceramic at least to below 600° C. is carried out, whereby the rate of cooling is at least 5 K/min, and, during the ceramization, the previously mentioned support plate is used. Exploited here is the effect that high-strength, highly transparent glass ceramic articles can be produced by way of a specific combination of nucleation and crystallization temperatures with specific residence times and a fast cooling rate.

A special advantage of the previously mentioned method for ceramization is the homogeneous crystallization, which is understood to mean a uniform distribution of the crystals or crystallites in the residual glass phase and very similar grain sizes. Such a distribution, on the one hand, reduces the light scattering and the differences in refractive index between the individual phases of the glass ceramic and, on the other hand, increases the transparency of the produced glass ceramic article. Therefore, the crystals have grain sizes with a standard deviation of less than +/−5%, preferably less than +/−3%, and particularly preferred of less than +/−2%. Suitable LAS glasses are glass ceramics with a composition range as given further above.

For control of the above-described parameters of the ceramization process, it is preferably possible to use an electrically heated kiln, preferably in the form of a continuous kiln, in particular a roller kiln, for the ceramization. In the ceramization, the support plate is used. However, it is also possible to use a batch kiln.

The ceramization can take place in the previously mentioned types of kiln; that is, a heating in 1 to 5 h to 750° C. to 980° C. can be realized, so that a flat plate containing high quartz mixed crystals (HQMC) as the primary crystal phase and a degree of crystallinity of 50% to 90% as well as a crystallite size of between 20 nm to 100 nm is formed.

In accordance with the invention, for the ceramization according to the first embodiment, the flat substrate made of ceramizable green glass is laid on the base support or support plate in such a way that the surface that has undergone post-processing smoothing rests on the support plate. Accordingly, the surface of the flat substrate that is treated by the smoothing fine-treatment process is in contact with the support plate during the ceramization.

The side of the substrate resting on this support plate generally represents, in later use, the back side. This is due to the fact that, in spite of the fine treatment of the substrate, the contact of the surface with the base support can leave behind small striations, adhering particles, or even imprints. This side is therefore preferably used as the back side in the final product, which faces away from the user.

This back side or bottom side of the substrate is the side on which the color-imparting, bottom-side coating is applied when the substrate is used as a transparent cooktop, for example, and the side that represents the side facing away from the observer and is intended for an installation as a hob, whereas the top side of the glass ceramic plate (which is generally additionally decorated during the ceramization process) faces the observer.

For use as, for example, a fire-protection laminated plate system, the back sides of the LAS glass ceramic plates in question can be subjected to a lamination process. For utilization as a support plate for the solar power industry, the side in question can be subjected to an ion-exchange process, for example, or can come in contact with other glasses in an electrical field.

In accordance with the invention, for the ceramization in accordance with the second embodiment, the flat substrate made of ceramizable green glass can be laid on the base support or support plate in such a way that the surface that has undergone post-processing smoothing does not rest on the base support. Accordingly, it is sufficient to process only one surface of the ceramizable green glass with the smoothing fine-treatment process, thereby making the method especially favorable. The surface of the ceramizable substrate that has undergone post-processing smoothing is therefore not in contact with the base support during the ceramization, but rather faces away from the base support and thus is directly exposed to the kiln atmosphere.

This has the great advantage that, on the surface of the ceramizable green glass that faces away from the base support, it is possible during the ceramization to create the desired glassy surface zone, which is explained further below, whereby, on account of the preceding fine treatment, this surface is free of undesired particles that have formed on the bottom side during the hot shaping processes and/or, furthermore, is free of pores or microstructures, this being appropriate for the purpose of a good transparency. This side of the article made of glass ceramic therefore exhibits the desired especially high chemical resistance against the attack of combustion products and, in a very favorable manner, can face the combustion space when it is used, for instance, as a viewing pane for stoves.

In a further development of this embodiment, a further fine treatment of the surface that was in contact with the support plate during the ceramization can take place after the ceramization. This has the advantage that foreign material from the ceramization process can be removed. If such a treated article made of glass ceramic is used, for example, as a firebox viewing pane, a less stringent requirement is placed on this side in terms of chemical resistance and strength. With this method, it is possible to achieve that, in a cost-effective manner, the microstructure is eliminated for a better transparency and, furthermore, that interfering relics from the hot shaping, which would lead to damage during a polishing after the ceramization, have been eliminated prior to the ceramization and, furthermore, that the relics formed during the ceramization are likewise eliminated. If then a flexible polishing pad is utilized, this kind of processing can be conducted in a very cost-effective manner, because it is not necessary to eliminate the waves by material removal, but rather only the microstructuring is smoothed.

During the ceramization in an electric or gas kiln, usually a lithium-poor glassy surface zone that is 200 nm to 2,000 nm thick and, for the most part, is generally amorphous can be formed on the top side of the LAS glass ceramic plate in question when the above-mentioned high quartz mixed crystals are present as the primary crystal phase in the resulting glass ceramic structure.

The method explained above makes it possible to create a flat, highly transparent article made of glass ceramic for use as a viewing pane with outstanding surface properties, in particular when LAS starting glasses are used. Based on its properties, it can fundamentally also be used as a window pane for vehicles, for instance. The surface quality of the flat article made of glass ceramic that is produced can be characterized on the basis of various characteristic values and product properties.

Accordingly, the subject of the invention is a flat, transparent article made of glass ceramic, which is preferably produced or can be produced in accordance with the above-mentioned method.

The article made of glass ceramic according to the invention is characterized by two parallel extending, very smooth surfaces, whereby the at least one surface can have a very high degree of gloss, which can be given as the DOI value, determined in accordance with the standard ASTM D 5767. In accordance with the invention, the DOI value is at least DOI>=85, preferably DOI>=90.

The glass articles made of glass ceramic with the method according to the invention have a very high transparency, so that, for example, even in the layered composite, the requirements for vehicle window panes are still met.

Thus, the articles made of glass ceramic according to the invention have a transmittance in the visible wavelength region, in relation to a wall thickness of 4 mm, of greater than 0.75 at 400 nm, greater than 0.845 at 450 nm, greater than 0.93 at 550 nm, greater than 0.90 at 600 nm, and greater than 0.90 at 700 nm wavelength.

Furthermore, this article has very high values for chemical resistance against the attack of combustion products, in particular against sulfur-containing exhaust gases, which contain compounds made of sulfur-containing acid or sulfuric acid and, for example, are formed during the combustion of wood and coal. Therefore, a good resistance toward sulfuric acid attack can be retained.

The waviness of the article made of glass ceramic is at most 500 μm, preferably at most 50 μm, and especially preferred at most 10 μm, measured as the difference in height between a wave valley and an adjacent wave peak. The achievable waviness of the wavelengths lies between 50 and 500 mm, preferably between 60 and 200 mm.

Beyond this, they can also exhibit high strength and thus be used as a glass ceramic for protective applications. In a comparison of the impact strength of unpolished and polished material that was produced in accordance with the method, it was possible to demonstrate a marked increase in strength for the polished material in accordance with the invention. This increase in strength is at least 20%.

In this case, the determination of the impact strength was produced on the basis of the ball drop test in accordance with DIN 52306. In this test, a steel ball weighing 200 g is allowed to drop from a defined height in free fall onto the middle of a sample of format 100×100×4 mm. The drop height is increased in steps until fracture occurs. The impact strength is a statistical quantity and its determination is carried out on a series of about 20 sample specimens. The analysis was conducted according to the Weibull model in accordance with DIN EN 61649.

Furthermore, it has been found that, as a result of the fine treatment and thus the reduction in the fine waviness of the at least one surface of the substrate prior to the ceramization, the surface topography that is typical for the rolled surface is further improved, so that post-processing of the article made of glass ceramic is no longer required; however, at the same time, even for a later utilization of the finished article made of glass ceramic as a viewing pane of baking ovens or fireplace stoves, it is even possible to achieve an optically attractive appearance when the appliances are turned off and the operator looks into a black interior.

This further leads to the fact that a lithium-poor (glassy) surface zone that is, for the most part, generally amorphous is retained.

The article made of glass ceramic according to the invention can assume here all known geometric sizes and shapes (flat, rounded, angled, three-dimensionally shaped), and additional elements, such as decorative colors, coatings, and designer edge cuts (e.g., flat facets) can be provided.

Accordingly, the present invention describes a method for the production of a flat, transparent article made of glass ceramic as well as a flat, transparent article made of glass ceramic, which can be used as a bullet-proof viewing pane (layered composites), as a hob, as a stove and fireplace viewing pane, as a glass ceramic object for high-temperature or extremely low-temperature applications, as a window for incinerators, as whiteware, as a plate for baking oven doors, as a support plate for precious metal coatings and thus as a cooktop for induction or gas heating, as a support plate for vacuum coating processes, in particular for solar functional layers, as a transparent baking oven plate, as a fire-protection plate, as a microwave turntable plate, as a support plate in the display industry and in the solar industry, or as a non-imprinted or imprinted hob or countertop or work table, which, in particular, is large in size, being at least 0.7 m², preferably at least 1.0 m² in surface area, and for other applications, in particular those applications subject to varying temperature load.

Further details of the invention ensue from the description of the exemplary embodiments presented and from the appended claims.

### BRIEF DESCRIPTION OF THE DRAWINGS

FIG. 1 schematically, a curved fireplace viewing pane in an oblique view,

FIG. 2 schematically, a straight fireplace viewing pane in an oblique view,

FIGS. 3a and 3b by way of example in each case, a view from the top onto a substrate prior to the ceramization during the removal of material,

FIG. 4 a comparison of the impact strength of unpolished and polished material,

FIG. 5 schematically, a transverse view of a hot shaping process by means of shaping rollers,

FIGS. 6a and 6b comparison of the transparency through two different articles made of glass ceramic,

FIG. 7 important method steps, starting from the hot shaping until the article made of glass ceramic is obtained,

FIGS. 8a-8c transverse views of an excerpt from a substrate made of ceramizable green glass in various processing steps,

FIGS. 9a and 9b schematic illustrations of different polishing heads,

FIGS. 10 and 11 exemplary embodiments of the material removing faces of flexible polishing heads, and

FIGS. 12 and 13 views from the top onto a transverse polished section of two articles made of glass ceramic with and without a glassy surface zone.

### DETAILED DESCRIPTION

In the following detailed description of preferred embodiments, for reasons of clarity, identical reference numbers refer to essentially identical parts in or on these embodiments. For better clarification of the invention, however, the preferred embodiments illustrated in the figures are not always drawn to scale.

With the method according to the invention, it is possible to produce a flat, transparent article made of glass ceramic, in particular for use as a viewing pane.

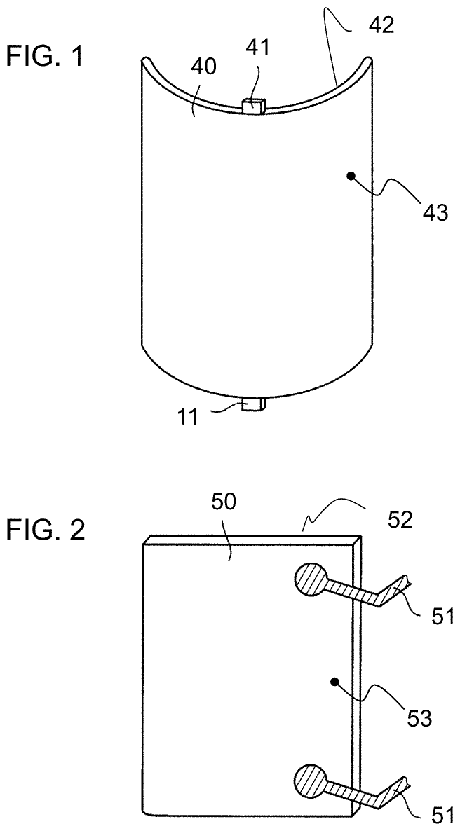

FIG. 1 shows, solely by way of example, schematically, a curved fireplace viewing pane 40 made of glass ceramic in an oblique view. Shown in FIG. 2, likewise solely by way of example, schematically, is a straight fireplace viewing pane 50 in an oblique view. Without any limitation to the illustrated exemplary embodiments, the fireplace viewing panes 40, 50 are designed with holding means 41, 51, which make it possible to mount the fireplace viewing pane 40, 50 in a fireplace in an especially simple manner. The illustrated fireplace viewing panes 40, 50 represent, solely by way of example, selected articles made of glass ceramic according to the invention and are produced with the method according to the invention.

In this case, the production comprises the preparation of a glass melt, whereby a batch that has a composition of a glass suitable for later ceramization and production of a glass ceramic is fed to a melting facility and is melted. By means of a rolling process for the hot shaping, a glass body made of ceramizable green glass is produced therefrom.

The ceramizable green glass here is based on the lithium aluminosilicate system and comprises nucleating agents, preferably TiO₂ and/or ZrO₂ or also SnO₂. In this case, the composition range (in wt. %) given below is especially suitable:
50-75 SiO₂, preferably 58-74 SiO₂, especially preferred 60-73 SiO₂,
15-28 Al₂O₃, preferably 15-25 Al₂O₃,
0-3.0 B₂O₃, preferably 0-2.0 B₂O₃,
0-1.0 F,
2.0-6.0 Li₂O, preferably 2.0-5.5 Li₂O, especially preferred 2.5-5.0 Li₂O,
0-6.5 CaO+SrO+BaO, preferably 0-6 CaO+SrO+BaO, especially preferred 0-5 CaO+SrO+BaO,
0-7.0 TiO₂, preferably 0-6.0TiO₂, especially preferred 0-5.0 TiO₂,
0-5.0 ZrO₂,
0-5.0 ZnO,
0-3.0 Sb₂O₃,
0-3.0 MgO,
0-3.0 SnO₂,
2.0-7.0 TiO₂+ZrO₂+SnO₂,
0-9.0 P₂O₅,
0-2.0 As₂O₃, preferably 0-1.5 As₂O₃,
0-4.0 Na₂O+K₂O, wherein the respective proportions lie within the ranges given below:
0-4.0 Na₂O,
0-4.0 K₂O,
preferably 0-3 Na₂O+K₂O, wherein the respective proportions lie within the ranges given below:
0-2.0 Na₂O,
0-2.0 K₂O;
especially preferred 0-1.2 Na₂O+K₂O, wherein the respective proportions lie within the ranges given below:
0-1.0 Na₂O,
0-0.5 K₂O;
as well as conventional refining agents such as Sb₂O₃, As₂O₃, SnO₂, Ce₂O₃, fluorine, bromine, and sulfate, for a water content of 0.01-0.08 wt. %.

The green glass that is produced in the rolling process is suitable for being ceramicized in a ceramization process and for being transformed into a glass ceramic. Accordingly, in the ceramizable green glass, the crystal formation has not yet taken place or at least not yet notably taken place. The ceramizable green glass produced in this way thus contains nucleating agents for crystal formation, but the crystalline fraction is still very low. In particular, the crystalline fraction of the ceramizable green glass is less than 20 vol %, preferably less than 10 vol %, and especially preferred less than 5 vol %.

The ceramizable green glass coming from the glass melt is fed continuously to at least one pair of shaping rollers in order to obtain the desired thickness. This can take place in a single rolling step, but can also occur in a plurality of steps with a plurality of shaping rollers that are arranged in succession. After the rolling, the ceramizable green glass rests on transport rollers, which serve for the transport. After the intended thickness has been achieved, the rolled ceramizable green glass is separated into pieces by scoring it and breaking it along these scores in order to obtain substrates made of ceramizable green glass.

In the sense of the invention, at least one surface of the ceramizable green glass produced in the rolling process is subjected to a smoothing fine treatment, in particular to a polishing or to a lapping process, whereby the crystalline proportion of the ceramizable green glass is less than 20 vol %, preferably less than 10 vol %, and especially preferred less than 5 vol %.

In accordance with the invention, in this case according to a first embodiment of the invention, the wave inclines on the surface of the ceramizable green glass are removed in the course of the smoothing fine treatment, whereas, according to a second embodiment of the invention, material is removed over the entire surface of the ceramizable green glass.

In accordance with the second embodiment, in the case of the viewing panes shown in FIGS. 1 and 2, the material has been removed from the surface 42, 52 of the substrate made of ceramizable green glass prior to the ceramization by the smoothing fine treatment using at least one material removal tool with at least one material removing face. In other words, the smoothing fine treatment was carried out on the side of the ceramizable green glass that, in operation, later represents the side with the required high chemical resistance. The surfaces 53 and 43 were additionally smoothed after the ceramization. Because, for the impact strength, the structure of the bottom side of the substrate or the back side 42, 52 facing the combustion space is relevant for use as a viewing pane, this additional processing does not negatively affect the impact strength.

For this purpose, directly after the scoring and breaking or the cutting into corresponding large formats at the melting tank, the flat substrate made of ceramizable green glass is polished with cerium oxide or other known polishing agents for glass.

In accordance with the first embodiment of the invention, the smoothing fine treatment in this case is conducted in such a manner that only the fine waviness is reduced to a predetermined extent. The removal of material here takes place down to a depth, measured from the surface, that represents about half of the amplitude of the waves. In accordance herewith, the surface in the region of wave valleys is retained in terms of its earlier nature.

In accordance with the second embodiment of the invention, the smoothing fine treatment in this case is conducted in such a manner that a removal of material, albeit to a lesser extent, takes place over the entire surface. Material is removed here not only in the region of wave inclines, but also in the region of wave valleys, so that, ultimately, a new surface is created by the smoothing fine treatment. In accordance with an especially preferred design of this embodiment, only the surface that, during the hot shaping, has stood in contact with at least one shaping roller and/or with transport rollers and is consequently the side that can most likely be contaminated with particles, is subjected to a smoothing fine treatment prior to the ceramization.

The first embodiment is characterized in that, by means of the smoothing fine treatment, the fine waviness of the surface of the substrate made of ceramizable green glass is reduced. The remaining, low degree of fine waviness leads to the fact that air pockets are strongly reduced in size upon contact with the very smooth base supports or support plates during the ceramization and, in part or for the most part, are even no longer present.

This embodiment offers the great advantage that not only is the fine waviness reduced, but also the interfering air pockets are hardly created or not at all created during the ceramization and, therefore, no further damage is brought about during the ceramization as a consequence of relative movements between the substrate and the base support. This embodiment is especially suitable for colored ceramizable green glass for the production of colored articles made of glass ceramic for which no high requirements are placed on the transparency.

The achievable waviness of the ceramizable green glass or of the substrate made of ceramizable green glass is at most 500 preferably at most 50 and most especially preferred at most 10 μm, measured as the difference in height between a wave valley and an adjacent wave peak. Furthermore, a low degree of waviness can be retained and, after the fine treatment, can be preferably at least 0.1 mm or at least 0.2 mm. The waviness of the wavelengths is between 50 and 500 mm, preferably between 60 and 200 mm, and especially preferred less than 135 mm.

The roughness of the surface of the substrate treated by the smoothing fine-treatment process in accordance with the first embodiment, in which predominantly wave inclines are removed, does not essentially change in this case. The maximum roughness Ra is at most 0.5 μm and preferably is 0.2 μm-0.5 μm, preferably at most 0.4 μm, especially preferred at most 0.3 μm.

In contrast, the roughness of the surface of the substrate treated by the smoothing fine-treatment process in accordance with the second embodiment, in which the material removal takes place over the entire surface, is less than the original roughness and is Ra<0.02 μm, preferably Ra<0.010 μm.

The following two TABLES 1 and 2 show, by way of example, measured roughness values of a surface of a ceramizable green glass prior to the smoothing fine treatment and afterwards.

TABLE 1
Measured roughness values of a surface of a ceramizable
green glass prior to the smoothing fine treatment

| | | | Comment |
|---|---|---|---|
| Top | Ra | 0.090 | Mean |
| side | Rz | 0.489 | value |
| Bottom | Ra | 0.114 | |
| side | Rz | 0.660 | |

TABLE 2
Measured roughness values of a surface of an article
made of glass ceramic in accordance with the invention
after the smoothing fine treatment.

| | | Polishing | Polishing | |
|---|---|---|---|---|
| | | agent 1 | agent 2 | Comment |
| Top | Ra | 0.018 | 0.017 | Mean |
| side | Rz | 0.161 | 0.153 | value |
| Bottom | Ra | 0.018 | 0.017 | |
| side | Rz | 0.148 | 0.142 | |

The values of the mean roughness Ra and of the mean roughness depth Rz, given in TABLE 2, show, on the basis of two examples, the qualities that can be achieved for articles made of glass ceramic in accordance with the invention. The articles were subjected here to a smoothing fine treatment using different polishing agents 1 and 2. In this case, the surface referred to as the top side was treated over the entire surface area prior to the ceramization in accordance with the second embodiment of the invention, whereas the surface referred to as the bottom side was treated after the ceramization.

TABLE 3
Grain size distribution of the polishing agents 1 and 2.

| | | | | RARE EARTH OXIDE BASIS | | | |
|---|---|---|---|---|---|---|---|
| D50 Laser | μm | 2.0 | 3.0 | CeO₂ | % | 55 | min |
| 15 μm Oversize | % | <= | 0.5 | | | | |
| REO | % | >= | 85 | | | | |

The polishing agents 1 and 2 that were utilized are based on a slurry with a suspension of cerium oxide (CeO₂) in water. The two polishing agents 1 and 2 differ in terms of the mean particle size D50 (“D50 laser”), wherein the respective values are D50=2.0 μm or D50=3.0 μm. Mean particle sizes up to about D50=5.0 μm can also be regarded as being suitable.

The smoothing fine treatment here takes place using a material removal tool. The material removal tool in this case has at least one material removing face that rotates around an axis perpendicular to the material removing face. The material removal tool is guided here along predetermined tracks, for example, with constant advance, but different process parameters, such as pressure and speed of rotation, over the post-processed surface, whereby the tracks overlap one another. In addition, bonded and/or loose abrasive is or are added as a grinding agent, and/or a cooling agent is added.

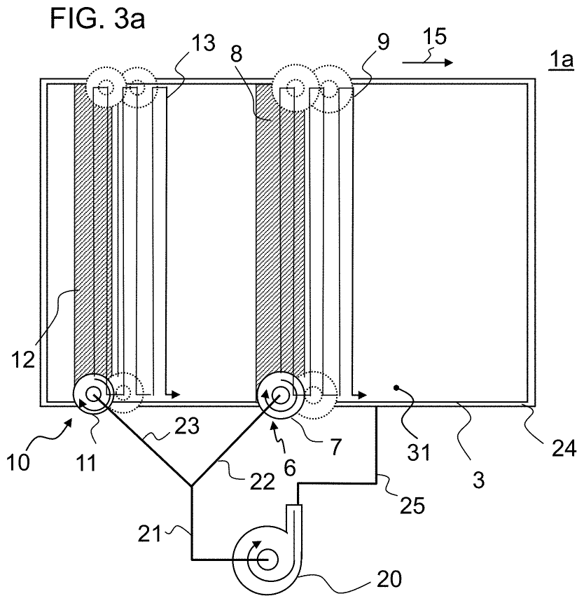

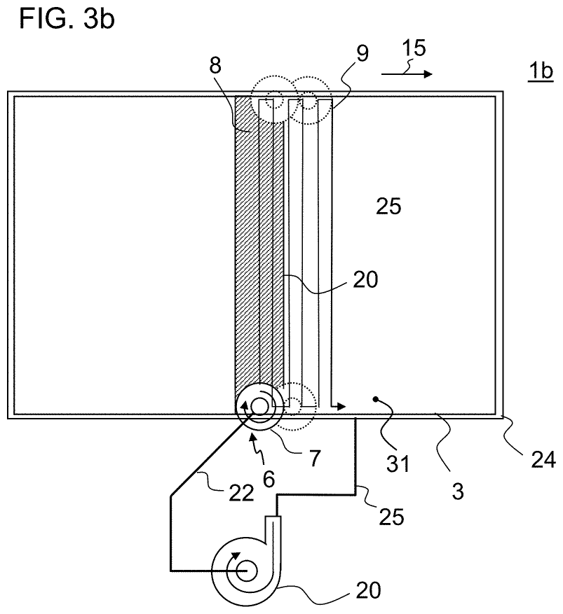

FIG. 3a shows, solely by way of example, a device 1a of a possible embodiment for the smoothing fine treatment of the substrate 3 made of ceramizable green glass. The method and the device 1a configured for carrying out this method are based on the fact that with a plurality of material removal tools 6, 10, material is simultaneously removed from the surface 31 of a glass or glass ceramic plate 3 that is to be post-processed, whereby the material removal tools 6, 10 have material removing faces 7, 11 that each rotate around an axis perpendicular to the material removing face 7, 11, whereby the material removal tools 6, 10 are guided along predetermined tracks 8, 12 over the surface 31 that is to be post-processed, whereby the tracks 8, 12 overlap one another, and whereby at least one first material removal tool 6 grinds the surface 31 that is to be post-processed with a grinding agent having a first grit and at least one second material removal tool 10 polishes the surface that has been ground by the at least one first material removal tool 6 with a second grinding agent, which, in comparison to the first grinding agent, has a finer grit, whereby the second grinding agent comprises a slurry, and whereby this slurry is also introduced during the grinding between the material removing face 7 of the at least one first material removal tool 6 and the surface 31 that is to be post-processed.

In FIG. 3a, only one of tracks 8, 12 that are traversed by the tools 6, 10 is illustrated as a cross-hatched area in each case. Overall, for the processing of the entire surface 31, the material removal tools 6, 10 are guided along tracks that are parallel to one another over the surface.

For this purpose, as illustrated on the basis of the paths 9, 13, a meandering movement is made by the tools 6, 10 against the surface 31. In order to carry out such a movement, the material removal tools 6, 10 are moved forward and backward along the tracks 8 and 12 and, in each case, after a forward and backward movement, the substrate is moved a bit further along the direction of advance 15. In order for both the tracks 8 and also the tracks 12 to each overlap one another, the advance is less than the diameter of the material removing faces 7 and 10. The overlap of the tracks 8, just like that of the tracks 12, here is preferably at least 20%, especially preferred at least a third of the diameter of the material removing face or, corresponding to it, the respective track width.

Obviously, it is also possible to design the device in such a way that only one material removal tool is employed. For this purpose, FIG. 3b shows, solely by way of example, a device 1b of a possible further embodiment for the smoothing fine treatment of the substrate 3 made of ceramizable green glass, whereby the device 1b is based on a single material removal tool 6.

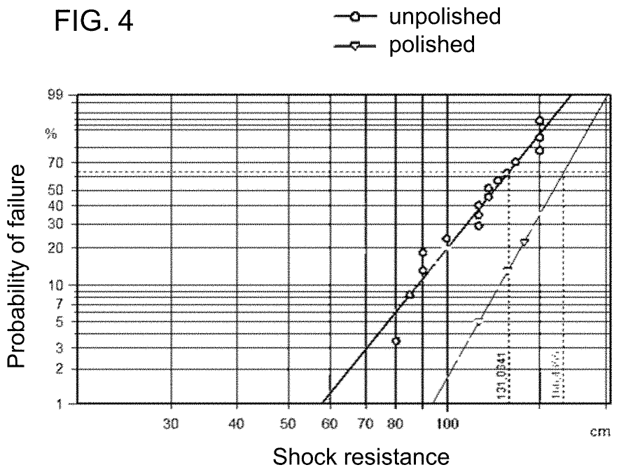

FIG. 4 shows a comparison of the impact strength of unpolished and polished material, which was produced in accordance with the method. It can be clearly seen that there is an increase in strength, which, in the example, is at least 20%, for polished material in accordance with the invention, which was polished on the side relevant to the impact strength prior to the ceramization.

The determination of the impact strength in this case is produced according to the following method on the bases of the ball drop test in accordance with DIN 52306. In this test, a steel ball weighing 200 g is allowed to drop from a defined height in free fall onto the middle of the sample, that is, onto the article made of glass ceramic, in a format of 100×100×4 mm. The drop height is increased in steps until breakage occurs. The impact strength is a statistical quantity and is determined on a series of about 20 sample specimens. The analysis is produced according to the Weibull model in accordance with DIN EN 61649.

The exemplary embodiment shown in FIG. 4 shows that, in accordance with the invention, it is possible to increase the strength markedly. In other examples, an increase in strength of the article made of glass ceramic of 10% or even of more than 20% could be determined.

After the smoothing fine treatment of the at least one surface of the substrate made of ceramizable green glass, there occurs a ceramization for the production of the flat, transparent article made of glass ceramic.

In accordance with the first embodiment of the invention, after the smoothing fine treatment, the substrate made of ceramizable green glass is applied, with the treated surface resting on the base support or support plate. In this embodiment, owing to the reduction in the fine waviness, the relative movement of the resting substrate is strongly reduced or, in the ideal case, no longer takes place when it travels through the roller kiln.

In accordance with the second embodiment of the invention, after the smoothing fine treatment, the substrate made of ceramizable green glass is applied on the base support or support plate, with the treated surface facing upward. This surface, which, on the basis of the fine treatment, is free of microstructures and/or particles, thus faces upward during the ceramization and thus is more strongly exposed to the prevailing kiln atmosphere, so that the creation of the desired glassy surface zone is achieved especially well.

In this way, an article made of glass ceramic in accordance with the invention is obtained. This is followed by the usual post-processing treatments of the article, such as, for instance, cutting into pieces or the introduction of a facet, or also the imprinting.

It is noted at this point that the curved construction of the fireplace viewing pane 40 in accordance with FIG. 1 is based on a reshaping of the article made of glass ceramic subsequent to the ceramization. In order to produce a curved fireplace viewing pane 40, such as shown in FIG. 1, therefore, a gravity sagging of the article made of glass ceramic into a corresponding mold follows.

The exemplary embodiments depicted in FIGS. 1 and 2 for the article made of glass ceramic produced in accordance with the invention comprise front sides 43, 53, as well as an opposite-lying back sides 42, 52, which, in the exemplary embodiments, are facing the combustion space.

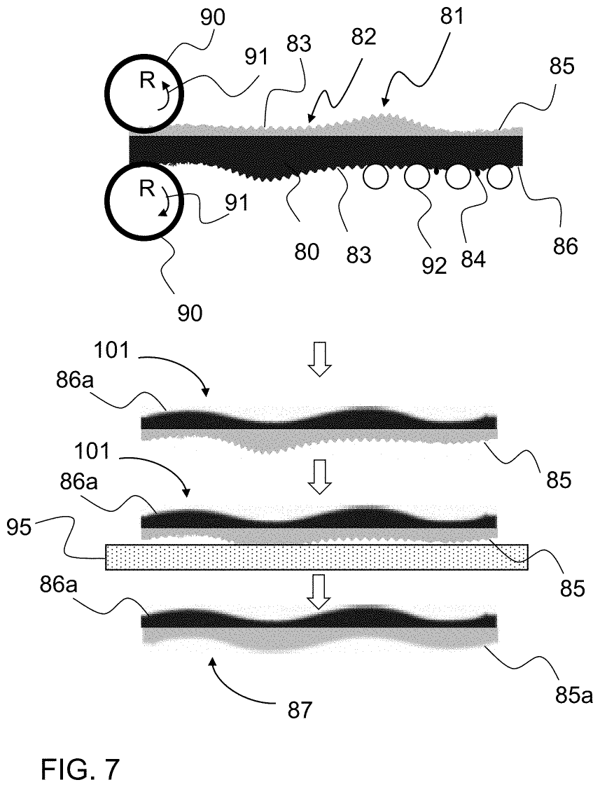

During a smoothing fine treatment and ceramization in accordance with the second embodiment, this side represents the side that was subjected to fine treatment and, during the ceramization, did not rest on the base support. FIG. 7 further below clarifies important method steps.

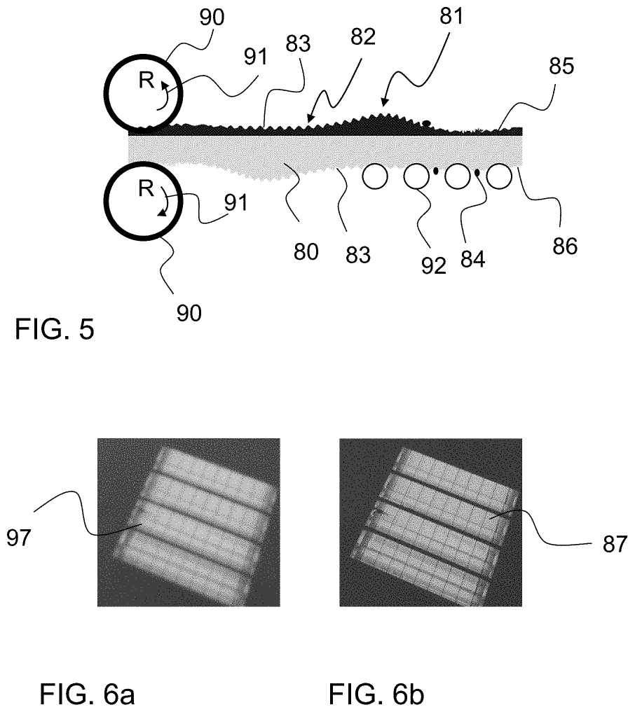

FIG. 5 first shows, in a schematic manner, in a transverse view of one example, an excerpt of a hot shaping process by means of two shaping rollers 90 operating in opposite rotation, which, in operation, have a rotational movement indicated by “R” and which roll ceramizable green glass. Moving between these shaping rollers 90 is ceramizable green glass 80, coming from the glass melt (not shown) in the form of a flat, continuous glass ribbon. Obviously, it is also possible for more than one set of shaping rollers 90 to be employed in order to roll the ceramizable green glass to the predetermined thickness. The ceramizable green glass 80 is guided here over transport rollers 92, which likewise are only drawn solely by way of example. In the illustration, four transport rollers 92 are drawn.

Solely by way of example, the rolled ceramizable green glass 80 is illustrated with characteristic waves or fine waves, whereby, in this case, the reference number 81 indicates a wave peak and the reference sign 82 indicates a wave valley.

The rolled surfaces of the ceramizable green glass 80 further have a microstructuring in the form of open pores 83, which represent the so-called “orange skin.”

Furthermore, the rolled surfaces of the ceramizable green glass 80 have particles 84, which can be manufacturing relics or other contaminants. They can rest on or adhere to the surface, but preferably appear on the bottom side, because this side is in contact with the glass.

It is obvious that the depicted waves, microstructures, and particles are just illustrated solely by way of example and, consequently, can be present in different shape, size, and appearance. Thus, for example, the particles 84 can also be present only on one surface, in particular on the bottom side, and not on both sides.

FIGS. 6a and 6b show, solely by way of example, the problem posed by transparency through two different articles made of glass ceramic. In FIG. 6a, an article 97 made of glass ceramic is illustrated in which the above-described surface flaws result in a marked deterioration in the transparency and lead to the fact that, in the case of transparency, a “blurred” impression is created for the human eye with fuzzy, not clearly defined contours of an object lying on the other side of the article. In contrast, the article 87 made of glass ceramic in FIG. 6b, which was produced by use of the method according to the invention, behaves differently. In this case, a clear transparency is possible without the contours being fuzzy or not clearly defined.

FIG. 7 illustrates, in a schematic manner, important method steps for the example of the second embodiment of the invention, starting from the hot shaping and ending when the article made of glass ceramic is obtained

Frequently, most contaminants of the ceramizable green glass 80 having particles 84 are found on the side that stands in contact with the transport rollers 92 during the hot shaping. In the example, this is the bottom side 86.

In a most highly advantageous manner, therefore, this side 86 of the ceramizable green glass 80 is subjected to the smoothing fine treatment, that is, is processed and preferably polished in accordance with the invention, whereas the opposite-lying side 85, which had no contact with the transport rollers during the hot shaping, remains unchanged in its surface nature. Because this surface only had contact with the shaping roller, hardly any contamination with particles 84 from the transport rollers is to be feared.

Against this background, the ceramizable green glass 80 is separated into pieces and cut into sections and the substrates made of ceramizable green glass 100 produced in this way are subjected to a smoothing fine treatment with the bottom side 86 facing upward.

Prior to the fine treatment, therefore, the substrate 100 with the bottom side 86, which stood in contact with the transport rollers 92 during the hot shaping, is rotated upward and then subjected to smoothing fine treatment. After the fine treatment, a substrate 101 with a fine-treated surface 86a is obtained, as can be seen in FIG. 7.

Accordingly, this surface 86a, which has been subjected to a smoothing fine treatment, has a slightly reduced waviness in comparison to the original surface 86 of the ceramizable green glass. By way of the smoothing fine treatment of this surface 86a of the substrate made of ceramizable green glass 80, the microstructures, in particular the open pores 83 and/or the particles 84 on this surface 86a, are removed completely.

For the ceramization in the subsequent method step, this substrate made of ceramizable green glass 101 is laid on a base support, which, in the example, is a support plate 95, for the ceramization preparation. It thereby becomes evident that what is now the surface 85, with which the substrate 101 rests on the support plate 95, was formerly the surface 85 of the ceramizable green glass 80 during the hot shaping and now represents the bottom side. Accordingly, this surface 85 can still comprise, at least partially, microstructures and/or also particles.

During the ceramization (not depicted), it is possible for the glassy, lithium-poor zone to form on the top side of the substrate 101, that is, on the surface 86a, in a very advantageous manner, and, later, when the article is used, to offer an especially high chemical resistance. This surface 86a is characterized in that, as a result of the smoothing fine treatment, it is, in addition, pore-free and particle-free and needs no further post-processing.

Obtained in this way is an article 87 made of glass ceramic according to the invention.

Optionally, a further method step can follow, in which the bottom side 85 of this article 87 made of glass ceramic is subjected once again to a fine treatment in order to produce, after the ceramization, a surface 85a that has undergone a smoothing fine treatment. A smoothing fine treatment after the ceramization makes it possible to remove particles that, for instance, arise during the ceramization and adhere to the surface 85.

The embodiment of the article 87 made of glass ceramic shown in FIG. 7 shows a processing of this kind, whereby, prior to the ceramization, the one surface 86a and, after the ceramization, the opposite-lying surface 85a have been subjected to smoothing fine treatment.

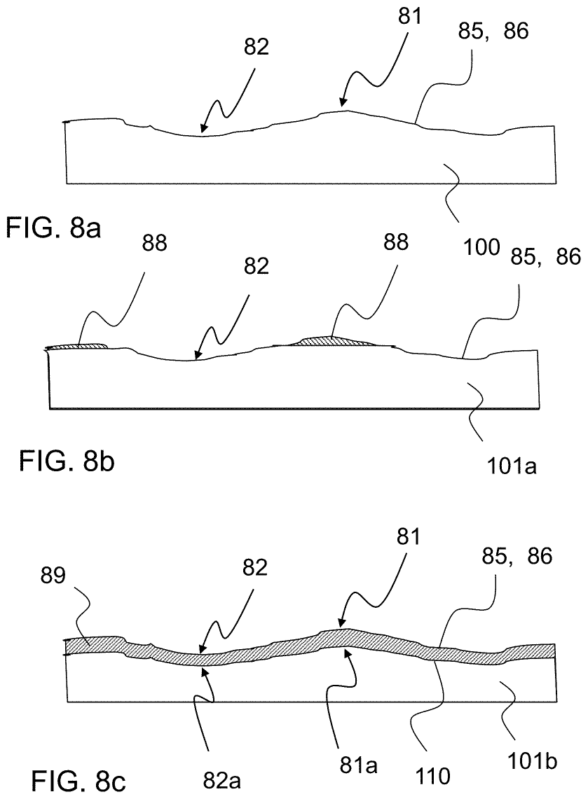

FIGS. 8a, 8b, and 8c show the difference in the smoothing fine treatment according to the two embodiments in accordance with the invention for a section of a ceramizable green glass 100, by way of example.

For this purpose, by way of example, an excerpt of a substrate made of ceramizable green glass 100 is illustrated in FIG. 8a. For simplicity, in the excerpt shown, only one surface 85, 86 is illustrated, and, in principle, may have been either the top side or the bottom side of the ceramizable green glass in the hot shaping. Furthermore, for reasons of clarity, only the waves are illustrated; the illustration of microstructures and particles has been dispensed with.

FIG. 8b shows the same excerpt of a substrate 101a made of ceramizable green glass, in which a surface 85, 86 in accordance with the first embodiment has been subjected to a smoothing fine treatment. The material 88 of the wave inclines was removed, whereas, in contrast, the wave valleys 82 were retained. In accordance therewith, the surface in the region of wave valleys 82 continues to have its former nature, whereas the waviness has decreased owing to removal of the material of the wave inclines and the creation of correspondingly flattened areas.

FIG. 8c shows the excerpt of a substrate 101b made of ceramizable green glass shown in FIG. 8a. In the illustration, the region 89 shown with cross-hatching is the material that is removed in accordance with the second embodiment of the invention. Accordingly, for the substrate 101b subjected to a smoothing fine treatment, material is removed over the entire area of the surface. Accordingly, in this case, material is removed both in the region of wave inclines 81 and in the region of wave valleys 82 and a new surface 110 is created, which replaces the former surface 85, 86. This new surface further comprises wave valleys 82a and wave inclines 81a.

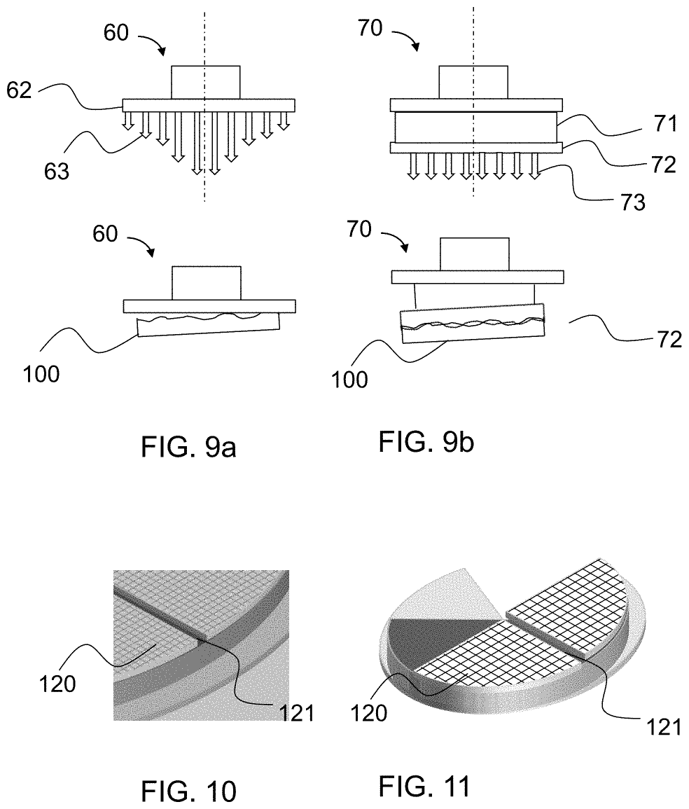

FIGS. 9a and 9b show, in a schematic illustration in a transverse view, two polishing heads 60, 70, which can be used as material removal tools 6, 10 for the smoothing fine treatment. Whereas the polishing head 60 has a rigid material removing face 62, the polishing head 70 is designed as a flexible material removing head and, for this purpose, has a flexible intermediate layer 71, which affords the material removing face 72 a better pliability over the entire material removing face. The force arrows 63, 73 show qualitatively, solely by way of example, the course of the contact pressure when the polishing heads 60, 70 are utilized.

The flexible intermediate layer 71 can comprise a pliable material, such as, for instance, a flexible polyurethane. For the smoothing fine treatment in accordance with the second embodiment, the flexible polishing head 70 is especially well-suited, because it can remove material in a uniform and distributed manner over the surface area. The utilization of the rigid polishing head 60, in contrast, leads to the fact that initially material in the region of wave inclines is removed and is thus suitable for a smoothing fine treatment in accordance with the first embodiment.

FIGS. 10 and 11 show exemplary embodiments of the material removing faces of flexible polishing heads 70. Shown in the depiction are so-called polishing pads 120, which are designed as quarter circles. Between this total of four segments of polishing pads 120 in each case, small grooves 121 are formed and assist the material transport during the removal of material. The polishing pads 120 can comprise a felt or an elastomer, preferably polyurethane.

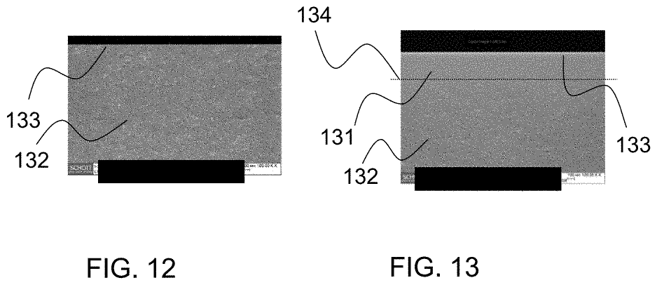

FIGS. 12 and 13 show a view from the top of a transverse polished section of two articles made of glass ceramic. FIG. 12 shows a transverse polished section of an excerpt of an article made of glass ceramic for which material was removed from the surface down to a depth of about 6 μm. There is no longer any glassy surface zone; the glass ceramic 132 extends to the surface 133.

In the transverse polished section shown in FIG. 13, what is involved is an excerpt of an article made of glass ceramic, which was produced in accordance with the invention. In this case, a glassy surface zone 131 can be seen, which has a thickness of about 100 nm and which then transitions into the actual glass ceramic 132. The transition region of the glassy surface zone 131 to the glass ceramic 132 is indicated by the dotted line 134, whereby the transition is seamless. This glassy surface zone 131 leads to the high chemical resistance of the article made of glass ceramic produced in accordance with the invention.

What is claimed is:

1. A method producing a flat, transparent articles made of glass ceramic, comprising:
producing a melt with a raw material composition configured for ceramization;
hot shaping a flat substrate made of ceramizable green glass having two oppositely arranged, flat surfaces from the melt;
processing a first surface of the two flat surfaces with a smoothing fine-treatment process to a waviness of at most 500 μm; and
ceramizing the flat substrate.

2. The method of claim 1, wherein the step of processing further comprises processing a second surface of the two flat surfaces with the smoothing fine-treatment process to the waviness of at most 500 μm.

3. The method of claim 1, wherein the ceramizable green glass is a lithium aluminosilicate system and/or comprises a nucleating agent selected from a group consisting of TiO₂, ZrO₂, SnO₂, and combinations thereof and/or has a crystalline fraction that is less than 20 vol %.

4. The method of claim 1, wherein the raw material composition comprises a composition range (in wt. %) of:

| | |
|---|---|
| 50-75.0 | SiO₂, |
| 15-28.0 | Al₂O₃, |
| 0-3.0 | B₂O₃, |
| 0-1.0 | F, |
| 2.0-6.0 | Li₂O, |
| 0-6.5 | CaO + SrO + BaO, |
| 0-7.0 | TiO₂, |
| 0-5.0 | ZrO₂, |
| 0-5.0 | ZnO, |
| 0-3.0 | Sb₂O₃, |
| 0-3.0 | MgO, |
| 0-3.0 | SnO₂, |
| 2.0-7.0 | TiO₂ + ZrO₂ + SnO₂ |
| 0-9.0 | P₂O₅, |
| 0-2.0 | As₂O₃, |
| 0-4.0 | Na₂O, |
| 0-4.0 | K₂O, and |
| 0-4.0 | Na₂O + K₂O. |

5. The method of claim 4, wherein the raw material composition further comprises, for a water content of 0.01-0.08 wt. %, conventional refining agents selected from a group consisting of Sb₂O₃, As₂O₃, SnO₂, Ce₂O₃, fluorine, bromine, and sulfate.

6. The method of claim 1, wherein the step of hot shaping comprises rolling the melt between a pair of rollers that rotate in opposite directions relative to each other.

7. The method of claim 1, wherein the step of processing the first surface with the smoothing fine-treatment process comprises:
rotating a material removal tool on the first surface around an axis perpendicular to the first surface; and
guiding the material removal tool along predetermined tracks over the first surface, wherein the predetermined tracks overlap one another.

8. The method of claim 7, further comprising feeding a material selected from a group consisting of bonded abrasive, loose abrasive, cooling agent, and combinations thereof.

9. The method of claim 1, wherein the step of processing the first surface with the smoothing fine-treatment process comprises removing material from wave inclines on the first surface, while retaining material in wave valleys on the first surface.

10. The method of claim 1, further comprising supporting the flat substrate on a smooth base support during the step of ceramizing, and wherein the step of ceramizing comprises a batch kiln ceramizing or a continuous kiln ceramizing.

11. The method of claim 10, wherein the first surface is supported on the smooth base support during the step of ceramizing.

12. The method of claim 10, wherein the first surface is not supported on the smooth base support during the step of ceramizing.

13. The method of claim 1, wherein the step of processing the first surface with the smoothing fine-treatment process comprises a step selected from a group consisting of: removing material from an entire area of the first surface to a depth from about 0.1 μm to 5 μm; processing the first surface so that the waviness has a wavelength between 50 and 500 mm; processing the first surface so that only wave inclines on the first surface are processed; processing the first surface to a maximum roughness of at most 0.5 μm; processing an entire area of the first surface to a roughness of less than 0.010 μm; and any combinations thereof.

14. An article comprising:
a flat substrate made of glass ceramic having two oppositely arranged, flat surfaces;
a first surface of the two flat surfaces having a waviness of at most 500 μm prior to ceramizing; and
a transmittance in a visible wavelength region, in relation to a wall thickness of 4 mm, of greater than 0.75 at 400 nm, greater than 0.845 at 450 nm, greater than 0.893 at 550 nm, greater than 0.90 at 600 nm, and greater than 0.90 at 700 nm wavelength.

15. The article of claim 14, wherein the first surface has a chemical resistance against attack of materials selected from a group consisting of sulfur-containing exhaust gases, sulfur-containing acid, sulfuric acid, and combinations thereof.

16. The article of claim 14, wherein the waviness is at most 200 μm and a waviness wavelength between 50 and 500 mm.

17. The article of claim 14, wherein the glass ceramic comprises a lithium-poor, glassy surface zone.

18. The article of claim 17, wherein the lithium-poor, glassy surface zone has a thickness, measured from the first surface, of between 200 nm and 2,000 nm.

19. The article of claim 14, wherein the flat substrate is configured for a use selected from a group consisting of a viewing pane, a bullet-proof viewing pane, a view pane for oven doors, a transparent baking oven plate, a fire-protection plate, a microwave turntable plate, a cooktop, and a fireplace viewing pane.

20. The article of claim 19, wherein the first surface comprises a surface area of at least 0.7 m².
